(19) United States
(12) Patent Application Publication
(10) Pub. No.: US 2020/0394479 A1
(43) Pub. Date: Dec. 17, 2020

(54) ENCODER PROVIDING ERROR DETECTION

(71) Applicant: HEWLETT-PACKARD DEVELOPMENT COMPANY, L.P., Houston, TX (US)

(72) Inventors: Vicente GRANADOS ASENSIO, Sant Cugat del Valles (ES); Luis Miguel BRUGAROLAS, Sant Cugat del Valles (ES); Juan Manuel ZAMORANO, Sant Cugat del Valles (ES)

(73) Assignee: HEWLETT-PACKARD DEVELOPMENT COMPANY, L.P., Houston, TX (US)

(21) Appl. No.: 16/089,307

(22) PCT Filed: Apr. 25, 2017
(86) PCT No.: PCT/US2017/029304

§ 371 Date: Sep. 27, 2018

(51) Int. Cl. G06K 15/00; B33Y 30/00; B33Y 50/02

(52) U.S. Cl. CPC G06K 15/408; B33Y 50/02; B33Y 30/00

(57) ABSTRACT

Movement detection circuitry is provided for a moveable component of an apparatus having an encoder member having a plurality of spaced regions to cause a response by a first detector and a second detector on the moveable component. First and second detection signal detection signals are received respectively from the first detector and second detector by processing circuitry of the movement detection circuitry. At least one of the first detection signal and the second detection signal is sampled when the first detector and second detector move relative to the encoder member. An error due to any impairment to one the spaced regions of the encoder member is based upon a comparison between the samples from the two detectors. A movement characteristic of the moveable component is determined by the processing circuitry from at least one of the first detector samples and the second detector samples.

### BACKGROUND

Many devices make use of encoder systems for detecting position of a moving part of the device. An encoder member may have markings to encode position and a sensor, often attached to a moving part of the device, may read the markings to determine a position that may be used to detect movement in the moving part. The encoder system may be part of a motion controller of the device. Encoder systems include optical, magnetic, inductive, capacitive, and eddy current sensors. Optical encoders may be the most accurate, but they can be susceptible to errors due to contamination from dust, dirt and vibration common in industrial environments. Magnetic encoders may be more resilient to contamination by dirt than optical encoders but tend to provider lower resolutions.

Encoder systems may be used in a range of devices including printers and scanners, medical imaging systems, machine tools, semiconductor handling and test equipment, and robotic devices. In any of these devices the encoder system may be susceptible to blockage, scratching or otherwise impaired operation of one or more regions (markings) of an encoder member.

### BRIEF DESCRIPTION OF THE DRAWINGS

Examples are further described hereinafter with reference to the accompanying drawings, in which:

FIG. 1 is a diagram of an example of a print head carriage for a 3D printer;

FIG. 2 is a diagram of an example of a movement detection circuitry;

FIG. 3 is a diagram of an example of a waveform chart showing example detection signals of detection sensors of a detector of the FIG. 2 example;

FIG. 4 is a diagram of a further example of movement detection circuitry; and

FIG. 5 is a flow diagram outlining an example method of detecting movement of a component.

### DETAILED DESCRIPTION

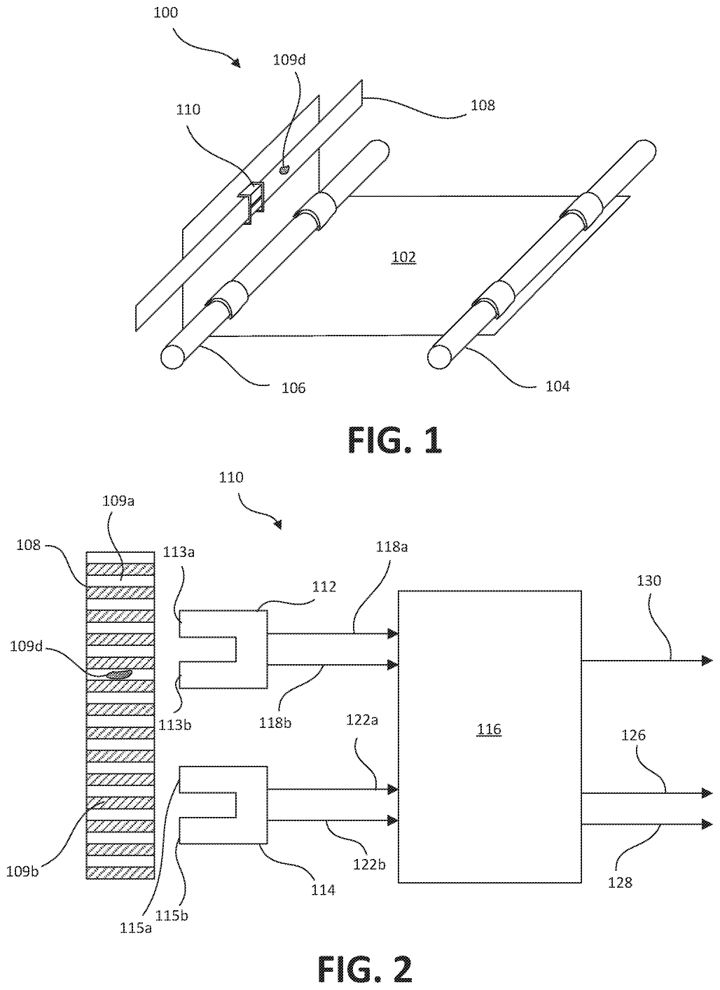

FIG. 1 shows a diagram of an example of a moveable component in the form of a print head carriage 100 for a 3D printer. The print head carriage 100 is for use in a 3D printing system. The 3D printing system may comprise a 3D printer (not shown) to generate three-dimensional objects on a layer-by-layer basis, which may be referred to as an additive manufacturing process. The three-dimensional objects are generated from build material which may be in the form of a powder. The build material is selectively fused together, in layers, to form three-dimensional objects. The fusing process may be as a result of the application of directed heat to the build material or as a result of a chemical process in which the build material is bound using chemical binders, and may result in significant amounts of heat within a volume of the build material. The build material may be or include, for example, powdered metal materials, powdered composite materials, powdered ceramic materials, powdered glass materials, powdered resin materials, powdered polymer materials and the like.

The print head carriage 100 typically comprises a print material applicator (not shown) for applying the print material therefrom. The print head carriage 100 comprises a print head carriage platform 102 moveable over a print area of the 3D printing system. In this example, the print head carriage platform 102 is moveable by translation along a first axis defined by a first guide rail 104 and a second guide rail 106. The print head carriage platform 102 is typically also moveable along a second axis, transverse to the first axis. In some examples, the print material applicator is moveable along the second axis. In examples, the print head carriage platform 102 or the print material applicator is moveable along a third axis, transverse to both the first axis and the second axis. However, alternatively, a print area forming a table in a horizontal plane may move relative to the print carriage so that the print carriage can move in a two-dimensional plane, yet a three dimensional object can be built up layer by layer.

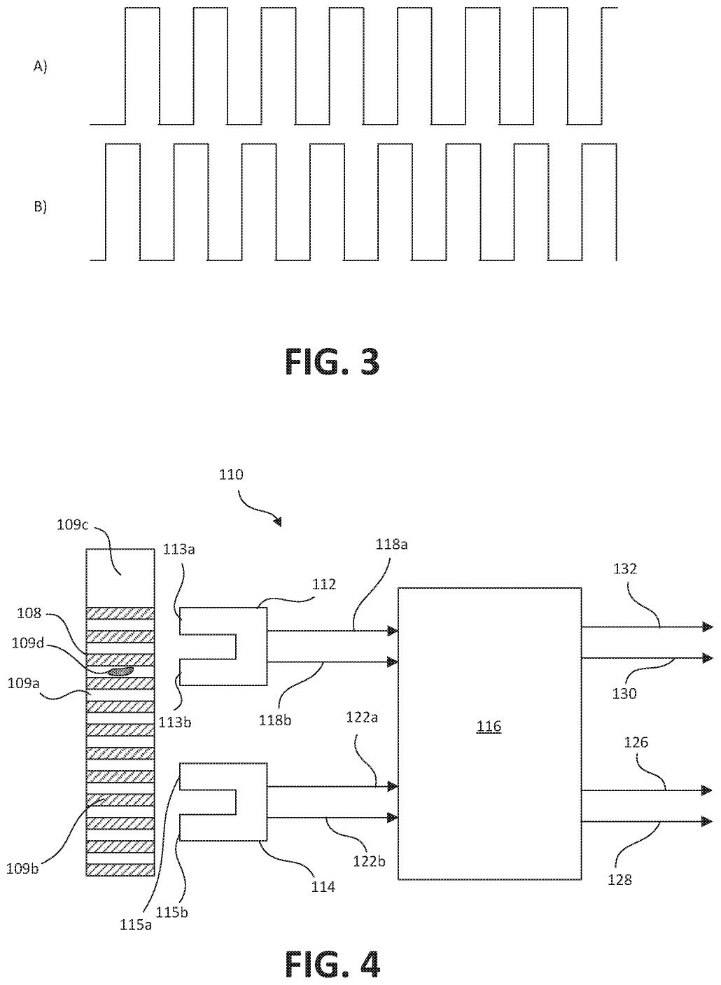

The print head carriage platform 102 is moveable relative to an encoder member, which in this example is an encoder strip 108. The encoder strip 108 comprises a plurality of closely spaced markings providing a scale that encodes position. In the arrangement of FIG. 1, the encoder strip is in a fixed position on in the printer and optical detectors 112, 114 move together with the print head carriage platform 102. In alternative arrangements, the encoder member may be affixed to the moving part and the detectors may be static. The encoder strip will be described further in relation to FIGS. 2 and 3 hereinafter. In alternative examples, the encoder member may differ in shape from a strip and may be, for example a rotary encoder member having a circular shape. In devices having print carriages moving along and axis an encoder strip may provide a convenient shape to encode position. The encoder strip or member may be provided on any moveable component of a printer, such as a spreader carriage. The encoder strip 108 passes within movement detection circuitry, in the form of a detector housing 110 mounted to the print head carriage platform 102. The detector housing 110 can be used to determine a movement characteristic of the print head carriage 100 relative to the encoder strip 108 using detectors of the detector housing 110 responsive to a plurality of spaced regions (not shown in FIG. 1) of the encoder strip 108. This is described further in relation to FIG. 2 below. In many environments, the encoder strip 108 is exposed to dust such as powder or other contaminants, during normal movement and operation of the print head carriage 100. An impairment in the form of a printing material deposit 109d is shown on the encoder strip 108. In examples, the printing material deposit 109d may scratch the encoder strip 108 to cause the impairment to the encoder strip 108, It will be understood that an encoder strip in other types of printer or apparatus may also be located in dusty environments. A detection technique providing resilience to such dusty environments will be described further in relation to FIG. 2 hereinafter. For example, in additive manufacturing systems such as three-dimensional, 3D, printing systems the printing material deposit 109d may be in the form of build material for example in powdered form. The build material can block position markings on an encoder member. In two-dimensional printing systems such as ink-jet printers, the printing material deposit 109d may be in the form of solidified deposits of printing liquid such as ink. The solidified deposits of printing liquid may impair position markings on an encoder member. In examples, the printing material deposit 109d is in the form of print agent from a print head of a printing system. In an example, the printing material deposit 109d is small relative to each of the plurality of spaced regions of the encoder strip 108. Therefore, the encoder strip 108 may not become impaired until printing material deposits 109d are present across substantially the whole of one or more of the plurality of spaced regions of the encoder strip 108.

A build-up of printing material deposits on one or more spacings of the encoder strip 108 may occur suddenly, via an instantaneous deposition causing rapid obstruction to one of the spacing or may occur more gradually over time. Gradual build-up of contaminants, which may not completely block light transmission or reflection from a spacing of the encoder strip 108 to the sensors may be detectable via changes in the form of detected signals 113a, 113b, 115a, 115b captured by one if the optical detectors 112, 114. For example a pulse width corresponding to a spacing may progressively broaden as a contaminant builds on the spacing causing a partial blockage and then a full blockage.

The printing material deposit 109d may be formed from any sort of contamination for example, where the device is a printer, the printing material deposit 109d may be a mixture of build material and/or printing liquid and/or print agent. Where the movement detection circuitry is used in a different type of apparatus, the encoder member could be impaired by any type of contamination, depending upon the apparatus and the environment in which the encoder member is used to a measure position of a moveable component of the apparatus.

FIG. 2 shows a diagram of an example of a movement detection circuitry for a printer. In this example, the movement detection circuitry 110 comprises a first detector 112 and a second detector 114. The first detector 112 and the second detector 114 are each responsive to a plurality of spaced regions 109a on the encoder strip 108. In this example, the plurality of spaced regions 109a are regularly spaced. The encoder strip 108 comprises a plurality of separating regions 109b, separating the spaced regions 109a and to cause a different response by the detectors 112, 114 to that from the spaced regions 109a. Thus, it can be determined whether the first detector 112 and/or the second detector 114 is/are adjacent one of the plurality of spaced regions 109a or one of the plurality of separating regions 109b based on a detection signal of the first detector 112 and/or the second detector 114. When the encoder strip 108 is at least partially located in a dusty environment, one or more of the plurality of spaced regions 109a can become impaired by dust, a scratch or other impairments. In FIG. 2, the printing material deposit 109d is impairing one of the plurality of spaced regions 109a. When the first detector 112 or the second detector 114 is located adjacent the spaced region having the printing material deposit 109d thereon, it may not be possible to determine that the first detector 112 or the second detector 114 is adjacent to a spaced region 109a because the detection signal will be different from that which would be produced in the absence of the printing material deposit 109d.

For the printing material deposit 109d located on a spaced region adjacent to the first detector 112, this will not be an impairment to a spaced region adjacent to the second detector 114. Thus, it is possible to detect an error due to the impairment caused by the printing material deposit 109d by comparing the detection signal from the first detector 112 with the detection signal from the second detector 114. In examples, the error is detected based on an anomaly in the detection signal from the second detector 114. In examples, it will be possible to obtain a movement characteristic of the print head carriage 100 using the detection signal from the second detector 114.

In an example where the printing material deposit 109d is located on a spaced region adjacent to the second detector 114, this will not be an impairment to a spaced region adjacent to the first detector 112. Thus, it is possible to detect an error due to the impairment caused by the printing material deposit 109d by comparing the detection signal from the first detector 112 with the detection signal from the second detector 114. In examples, the error is detected based on an anomaly in the detection signal from the first detector 112. In examples, it will be possible to obtain a movement characteristic of the print head carriage 100 using the detection signal from the first detector 112.

In an example, it is possible to identify an impairment of one of the spaced regions 109a based on a detection of an anomaly in samples of a detection signal of the first detector 112 replicated at a different time within a predetermined time period in the samples of the detection signal of the second detector 114. In examples, the predetermined time period may be determined based on a spacing between the first detector 112 and the second detector 114 and an expected speed or a previous speed of the moveable component in the form of the print head carriage 100.

In examples where the plurality of spaced regions 109a are regularly spaced, it is possible to determine a movement characteristic of the print head carriage 100 in the form of a speed of the print head carriage 100 relative to the encoder strip 108 based on a frequency of a repeating pattern of samples of the detection signal of the first detector 112 or the second detector 114. For example, if a spaced region 109a is provided every 2 millimetres, each having a width of 1 millimetre and separated by the separating regions 109b having a width of 1 millimetre, and if sample of the detection signal of the first detector 112 form a pattern repeating every 1 second, it can be determined that the first detector 112 is moving at a speed of 2 millimetres per second relative to the encoder strip 108. After a period of 4 seconds of the same repeating pattern of the detection signal, the first detector 112 will be positioned a distance of 8 millimetres away from an original position relative to the encoder strip 108.

It will be appreciated that the speed of the print head carriage 100 relative to the encoder strip 108 can be determined by the first detector 112, by the second detector 114 or separately by both the first detector 112 and the second detector 114. In examples where the speed is determined separately by both the first detector 112 and the second detector 114, a discrepancy between the two speeds can be indicative of an anomaly in the detection signal of the first detector 112 of the second detector 114 used to detect the error due to the impairment to the spaced region 109a. In examples, the anomaly can be determined to be in the detection signal of the first detector 112 when the speed determined using the samples of the detection signal of the first detector 112 is different from a previously determined speed by a predetermined threshold. In examples, the anomaly can be determined to be in the detection signal of the second detector 114 when the speed determined using the samples of the detection signal of the second detector 114 is different from a previously determined speed by a predetermined threshold.

In environments where powder or other dirt may be present, the encoder strip 108 may become stained or marked by powder, dirt or ink deposits. Without the error detection provided by the movement detection circuitry of FIG. 1 or FIG. 2, contaminants or damage to the encoder strip may be interpreted by the processing circuitry as a discontinuity on movement of the print carriage 102 which could result in movement control algorithms of the device attempting to adjust for the falsely detected discontinuity by causing undesirably transient movements in the moving part in an attempt to correct for the falsely detected discontinuity. Such erroneous detections of movement of the moving part can result in a ruined print job, for example, 3D printers can be susceptible to such false detections or erroneous movement of the print carriage because the environment tends to be powder rich regardless of efforts being made to reduce the powder present in the encoder chamber.

Furthermore, 3D printing jobs can take a long time to complete, such as more than ten hours. Detection of an error due to an impairment of the encoder strip can provide resilience by allowing movement control algorithms to take account to the detected error, reducing the likelihood of a 3D print plot suffering from erroneous movement control of the print carriage. To improve accuracy, impairments to the encoder due to dirt or scratches may be detected as the print job progresses, with provision of a second detector allowing effective correction of any errors arising from encoder strip impairments to be detected and pre-empted by using movement characteristics determined from an unaffected one of the pair of detectors 112,114.

In the examples of FIG. 1 and FIG. 2, as the encoder strip 108 moves relative to the detectors 112,114, the presence of the print material deposit 109d blocking a transparent line (or highly reflective portion) of the encoder strip may first be detected by one detector 112 and then be detected by the other detector 114, providing a “redundant” movement detection measurement, which duplicates a movement measurement when the encoder strip 108 is unimpaired, but allows for correction of a movement measurement made by one of the detector responding to an impaired portion of the encoder strip proximal to the print material deposit 109d.

In an example, the first detector 112 and the second detector 114 are optical detectors and the spaced regions 109a cause the response of the first detector 112 and the second detector 114 when light from a light source is transmitted to the first detector 112 and the second detector 114 via the spaced regions 109a. In an example, the spaced regions 109a are light-transmitting regions and are to be located between the light source and the detectors 112, 114. The light-transmitting regions need not be fully transparent, and in examples permit transmission of a different amount of light therethrough than separating regions 109b of the encoder strip 108. In an alternative example, the spaced regions 109a are light-reflecting regions and are to be located for reflecting the light from the light source to the detectors 112, 114. In examples, the light-reflecting regions facilitate specular reflection. Alternatively, the light-reflecting regions facilitate diffuse reflection. The light-reflecting regions need not be fully reflective, and in examples reflect a different amount of light to separating regions 109b of the encoder strip 108. The movement detection circuitry 110 comprises processing circuitry 116.

In an example, the first detector 112 is a quadrature detector having a first detection sensor 113a and a second detection sensor 113b. The processing circuitry 116 is to receive a first detection signal 118a, 118b. The first detection signal 118a, 118b comprises a first component 118a having a first phase and a second component 118b having a second phase, different from the first phase. In examples, the first component 118a and the second component are out of phase by 90 degrees. In an example, the second detector 114 is a quadrature detector having a first detection sensor 115a and a second detection sensor 115b. The processing circuitry 116 is to receive a second detection signal 122a, 122b. The second detection signal 122a, 122b comprises a first component 122a having a first phase and a second component 122b having a second phase, different from the first phase. In examples, the first component 122a and the second component 122b of the second detection signal are out of phase by 90 degrees.

It will be appreciated that the phase of the components of the detection signal refers to the spacing of the detection sensors of the detectors as a proportion of the spacing of the plurality of spaced regions 108a when the spaced regions 108a are regularly spaced. For example, a phase angle of 90 degrees corresponds to a spacing between centres of a sensitive surface of the detection sensors of the detectors of a quarter the spacing between centres of adjacent spaced regions 109a on the encoder strip 108. For example, if a spaced region 109a is provided every 2 millimetres, each having a width of 1 millimetre and separated by the separating regions 109b having a width of 1 millimetre, then a phase angle of 90 degrees corresponds to a separation between the centres of the sensitive surfaces of the detection sensors of the detectors of 0.5 millimetres.

In examples, the first detection sensor 113a and the second detection sensor 113b of the first detector 112 are spaced by a distance different from a whole-number multiple of half of the regular spacing of the plurality of spaced regions 109a of the encoder strip 108. The first detection sensor 115a and the second detection sensor 115b of the second detector 114 are spaced by a distance different from a whole-number multiple of half of the regular spacing of the plurality of spaced regions 109a of the encoder strip 108.

In examples, the first and second detection sensors 113a and 113b of detector 112 or 115a and 115b of the detector 114 are spaced relative to each other by a distance less than half of the regular spacing of the plurality of spaced regions 109a.

In examples where the detection sensors of the detector are spaced by a distance different from a whole-number multiple of half of the regular spacing of the plurality of spaced regions 109a, it is possible to determine a movement characteristic of the print head carriage 100 in the form of a direction of movement of the first detector 112 or the second detector 114 based on an order of samples received by the detection sensors of the detectors, the samples corresponding to similar points in a repeating pattern of samples of the detection signal of the first detector 112 or the second detector 114. For example, if the first detection sensor 113a of the first detector 112 is positioned rightwardly (i.e. in a first direction along the length of the fixed encoder strip) of the second detection sensor 113b, and at to the first detection sensor 113a provides a sample of the first detection signal S₁ and the second detection sensor 113b provides a sample of the first detection signal S₂, then the first detector 112 is also moving in a rightward direction if a value of a sample of the second detection sensor 113b changes to match S₁ before a value of a sample of the first detection sensor 113a changes to match S₂. Since in this example, the first and second detection sensors 113a and 113b are travelling together with the print head carriage platform 102, they are assumed to be moving in the same direction, but the relative timing of repetition of a particular detected pattern between the two detection sensors 113a, 113b of a given sensor allows a direction of motion of the print head carriage platform 102 to be deduced.

In examples where the detection sensors of the detector are spaced by a distance of quarter of the regular spacing of the plurality of spaced regions 109a, any values of the samples of the detection signal which are expected to repeat every quarter of the regular spacing of the plurality of spaced regions 109a can be ignored. Thus, it is possible to determine a direction of movement of the detector, even when the spacing between the detection sensors of the detector is quarter of the regular spacing of the plurality of spaced regions 109a.

It will be appreciated that the direction of movement of the print head carriage 100 relative to the encoder strip 108 can be determined by the first detector 112, by the second detector 114 or by both the first detector 112 and the second detector 114. In examples where the direction of movement is determined separately by both the first detector 112 and the second detector 114, a discrepancy between the two directions is indicative of an anomaly in the detection signal of the first detector 112 of the second detector 114 used to detect the error due to the impairment to the spaced region 109a. In examples, the anomaly can be determined to be in the detection signal of the first detector 112 when the direction of movement determined using the samples of the detection signal of the first detector 112 is different from an expected direction of movement. In examples, the anomaly can be determined to be in the detection signal of the second detector 114 when the direction of movement determined using the samples of the detection signal of the second detector 114 is different from an expected direction of movement. This allows a discontinuity in motion of the printer carriage to be distinguished from an error due to an impairment caused, for example, by build material having undesirably adhered to and blocked or at least partially obscured one or more markings on the encoder scale.

In an alternative example, the first detector 112 and the second detector 114 are spaced by a distance different from a whole-number multiple of half of the regular spacing of the plurality of spaced regions 109a.

FIG. 3 is a diagram of an example of a waveform chart showing detection signals of detection sensors of a detector. In an example, detection signal A is the first component of a detection signal having a first phase and detection signal B is the second component of a detection signal having a second phase. In this example, the phase difference between A and B is approximately 90 degrees, such that B is leading A by 90 degrees, or quarter of a cycle when the signals are originating on the left side of the waveform chart. It will be appreciated that the square wave waveform shown in FIG. 3 is a simplified example and other waveforms are possible and even likely. In some examples, the waveform has a sinusoidal shape. The detection signals A and B may become distorted by any discontinuity in movement of the moveable component whose movement is being monitored. For example, a change indirection of the moveable part, such as the printhead carriage is detectable by a change in the waveform. However contaminants such as the printing material deposit 109b may also cause changes to the regular waveforms A, B. For example a deposition of particulates such as build material may gradually obscure one or more of the spaced regions of the encoder strip 108, A deposition of particulate material or other contaminants may impair a number of spacings of the encoder strip. The deposition of contaminants is unlikely to be uniform along the length of the strip and this may be exploited by the pair of detectors 112, 114, which can detect one or more anomalies in the detected signals replicated by both detectors to more reliably detect the presence of contaminants on the encoder markings that could result in an error in determination of position, speed or direction of motion of the print head carriage 100. When samples from the first and second encoders 112, 114 indicate the same or a similar waveform change at the same time, this is likely to be due to a change in direction of the print carriage whereas if an anomaly is not replicated at the same time via waveform|(s) captured by the second detector then it is likely that the anomaly is due to an impairment of one or more spacings of the encoder strip 108. The impairment of an individual spacing may be full or may be partial.

In this example, returning to FIG. 2, the processing circuitry 116 receives the first detection signal 118a, 118b from the first detector 112 and receives the second detection signal 122a, 122b from the second detector 114. The processing circuitry 116 also samples at least one of the first detection signal 118a, 118b from the first detector 112 and the second detection signal 122a, 122b from the second detector 114 when the first detector 112 and the second detector 114 move relative to the encoder strip 108. The processing circuitry 116 also determines a movement characteristic of the moveable component in the form of the print head carriage 100 from the samples of the first optical detection signal 118a, 118b. Alternatively or additionally, the processing circuitry 116 determines a movement characteristic of the print head carriage 100 from the samples of the second optical detection signal 122a, 122b. In this example, the movement characteristic is a position of the print head carriage 100. Alternatively or additionally, the movement characteristic includes a speed of the print head carriage 100 relative to the encoder strip 108. Alternatively or additionally, the movement characteristic includes a direction of movement of the print head carriage 100. In examples, the position of the print head carriage 100 is one of a position relative to a previous position of the print head carriage 100 or an absolute position of the print head carriage 100.

The processing circuitry 116 also detects an error due to any impairment to one of the spaced regions 109a of the encoder strip 108 based upon a comparison between the samples of the first detection signal 118a, 118b and the samples of the second detection signal 122a, 122b.

In examples, the processing circuitry 116 also identifies as an impairment error, a detection of an anomaly in the samples of the first signal 118a, 118b replicated at a different time within a predetermined time period in the samples of the second detection signal 122a, 122b.

In examples, the movement detection circuitry 110 may also provide an output from the processing circuitry 116 in the form of an output detection signal 126, 128 based on at least one of the samples of the first detection signal 118a, 118b and samples of the second detection signal 122a, 122b. In examples where the first detection signal 118a, 118b comprises a first component 118a having a first phase and a second component 118b having a second phase, different from the first phase and where the second detection signal 122a, 122b comprises a first component 122a having a first phase and a second component 122b having a second phase, different from the first phase, the output detection signal 126, 128 also comprises a first component 126 having a first phase and a second component 128 having a second phase, different from the first phase.

In examples, the output detection signal 126, 128 can be a movement characteristic of the detectors 112, 114.

Thus, the output detection signal 126, 128 can provide a movement characteristic of the detectors 112, 114 relative to the encoder strip 108, even when one of the plurality of spaced regions 109a is impaired.

In an example, the movement detection circuitry 110 provides an error output 130 from the processing circuitry 116. The error output 130 is at least an indication of a blockage of one of the spaced regions 109a of the encoder strip 108.

FIG. 4 is a diagram of a further example of movement detection circuitry for a printer. The movement detection circuitry 110 shown in FIG. 3 is substantially similar to the movement detection circuitry 110 shown in FIG. 2 apart from the hereinafter noted distinctions. The encoder strip 108 comprises an index region 109c to cause a response by the first detector 112 and/or the second detector 114 different from that of a main region of the encoder strip 108. The main region includes the plurality of spaced regions 109a of the encoder strip 108. In an example, the index region 109c is light-transmitting and is spaced from the plurality of spaced regions 109a by the separating region 109b. In this example, the index region 109c has a length in a direction along the encoder strip 108 greater than any of the plurality of spaced regions 109a. In some examples the spaced regions 109a may be optically transparent.

Alternatively or additionally, the index region 109c has a length in a direction along the encoder strip 108 greater than any of the plurality of separating regions 109b. In an example, the processing circuitry 116 is to reset a position indicator of the moveable component in the form of the print head carriage 100 upon detection of the index region 109c by one of the first detector 112 and the second detector 114. In this example, the index region 109c is located at an end of the encoder strip 108. In an example, one but not the other of the first detector 112 and the second detector 114 can detect the index region 109c. The index region may be at either end of the encoder strip 108, away from an operative region (e.g. printing region) of the moveable component, but into which movement of one of the sensors is still possible within the movement trajectory. In an example, the movement detection circuitry 110 provides an end of encoder strip output 132. The end of encoder strip output 132 outputs an indication that at least one of the first detector 112 and the second detector 114 have reached an end of the encoder strip 108, denoted by the index region 109c.

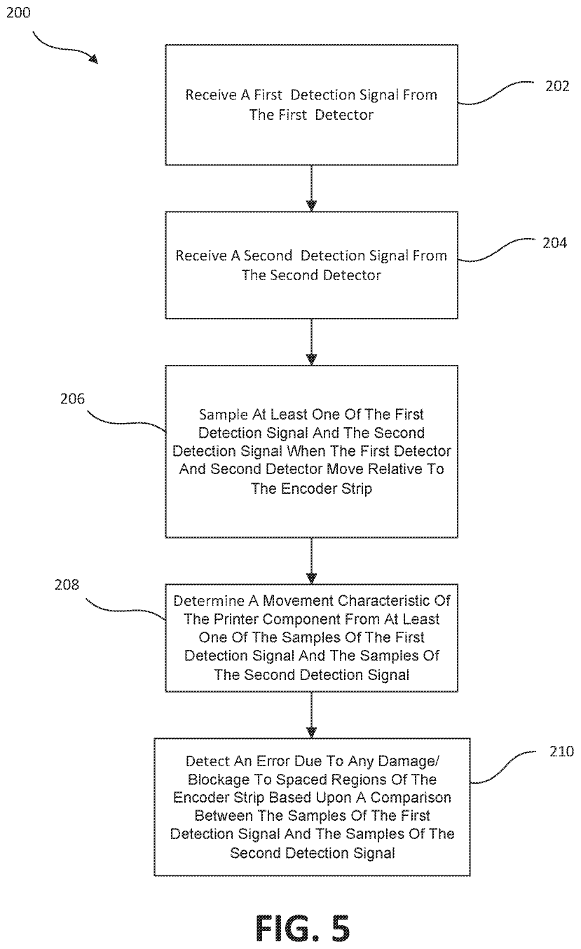

FIG. 5 is a flow diagram outlining a method of detecting movement of a component of a printer. In the method 200 of FIG. 4, at element 202, a first detection signal is received from a first detector. The first detector is to sample a first detection signal, such as an optical signal, representing a response to a scale of spaced markings (distance markings) on an encoder member, the encoder member (e.g. encoder strip) to allow movement detection to be performed for a movable component of an apparatus such as a printer. At element 204, a second detection signal is received from a second detector 114. The second I detector is to receive a second detection signal from the second detector representing a response of the detector to the markings on the encoder strip. Where the detectors are optical detectors they may detect light diffracted by or reflected from the encoder strip spaced regions (markings). At element 206, at least one of the first detection signal and the second detection signal are sampled when the first detector and the second detector, which are mounted on the movable component of the apparatus, move relative to the encoder strip. At element 208, a movement characteristic of the apparatus component is determined from at least one of the samples of the first detection signal and the samples of the second detection signal. Optionally, at element 210, an error due to any impairment, such as a blockage (or obscurement) of one of the optically transparent (or alternatively highly reflective) regions of the encoder strip 108 of the example of FIG. 2, may be detected based upon a comparison between the samples of the first optical detection signal and the samples of the second optical detection signal.

It will be appreciated that the phrase “impairment to one of the spaced regions of the encoder strip” covers at least a scratch or dirt from a 30 printing process or a 2D printing process or elsewhere on one of the spaced regions of the encoder strip, or any other impairment which could alter the response generated by a detector responsive to the spaced regions of the encoder strip.

It will be appreciated that examples described herein can be realised in printers, in particular 3D printers, 2D printers or in scanners, or indeed any apparatus having moveable components where it is possible to know a movement of the moveable component relative to a main portion of the apparatus.

It will be appreciated that examples described herein can be realised using optical detectors, capacitance detectors, magnetic detectors, or any other detector which can provide a detection signal when moved relative to an encoder strip having a plurality of spaced regions to cause a response by the detector.

It will be appreciated that examples described herein can be realised in the form of hardware, or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. The machine-readable storage may be transient storage such as a transmission medium or non-transient storage. Accordingly, examples provide a program comprising code for implementing a system or method as described herein and a machine readable storage storing such a program.

Throughout the description and claims of this specification, the words “comprise” and “contain” and variations of them mean “including but not limited to”, and they are not intended to (and do not) exclude other components, integers or process elements. Throughout the description and claims of this specification, the singular encompasses the plural unless the context implies otherwise. In particular, where the indefinite article is used, the specification is to be understood as contemplating plurality as well as singularity, unless the context implies otherwise.

In this specification, the phrase “at least one of A or B” should be interpreted to mean any one or more of the plurality of listed items, taken jointly and severally in any and all permutations.

Features, integers, characteristics or groups described in conjunction with a particular example of the disclosure are to be understood to be applicable to any other example described herein unless incompatible therewith. All of the features disclosed in this specification (including any accompanying claims, abstract and drawings), and/or all of the stages of any method or process so disclosed, may be combined in any combination, except combinations where at least some of such features and/or stages are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the stages of any method or process so disclosed.

1. Movement detection circuitry for a moveable component of an apparatus, the apparatus comprising an encoder strip having a plurality of spaced regions to cause a response by a first detector and a second detector on the moveable component, the movement detection circuitry comprising:
a first input to be connected to a first detector;
a second input to be connected to a second detector;
processing circuitry to:
sample at least one of a first detection signal from the first input and the second detection signal from the second input when the first detector and second detector move relative to the encoder strip;
detect an error due to any impairment to one of the spaced regions of the encoder strip based upon a comparison between the samples of the first detection signal and the samples of the second detection signal; and
determine a movement characteristic of the moveable component from at least one of:
the samples of the first detection signal; and
the samples of the second detection signal.

2. Movement detection circuitry as claimed in claim 1, wherein the first detector and the second detectors are optical detectors and wherein the spaced regions are to cause the response when light from a light source is transmitted to the first detector and the second detector via the spaced regions.

3. Movement detection circuitry as claimed in claim 1, wherein the processing circuitry is to identify as an impairment error, a detection of an anomaly in the samples of the first detection signal replicated at a different time within a predetermined time period in the samples of the second detection signal.

4. Movement detection circuitry as claimed in claim 1, comprising the first detector and the second detector.

5. Movement detection circuitry as claimed in claim 4, comprising the encoder strip.

6. Movement detection circuitry as claimed in claim 5, wherein the plurality of spaced regions of the encoder strip have a regular spacing, and wherein the first detector is spaced from the second detector by a distance different from a multiple of half of the regular spacing of the plurality of spaced regions, in a direction along a length of the encoder strip.

7. Movement detection circuitry as claimed in claim 1, wherein the movement characteristic comprises at least one of a position, a speed and a direction of movement of the moveable component.

8. Movement detection circuitry as claimed in claim 7, wherein the position of the moveable component is one of: a position relative to a previous position of the moveable component or an absolute position.

9. Movement detection circuitry as claimed in claim 1, wherein at least one of the first detector and the second detector is a quadrature detector and the corresponding first detection signal or second detection signal comprises two different phase components.

10. Movement detection circuitry as claimed in claim 1, wherein the encoder strip has an index region to cause a response by the first detector and the second detector different from that of a main region of the encoder strip and wherein the processing circuitry is to reset a position indicator of the printer component upon detection of the index region by one of the first detector and the second detector.

11. Movement detection circuitry as claimed in claim 10, wherein the index region of the encoder strip is located in a region of the encoder strip to correspond to a moveable component location away from an operative region of the moveable component.

12. Three dimensional, 3D, printer comprising the movement detection circuitry as claimed in claim 1, wherein the moveable component is a component of the 3D printer.

13. Machine readable instructions to detect movement of a moveable component of a three-dimensional, 3D, printer having an encoder member with a plurality of spaced regions to cause a response by a first sensor and a second sensor, the machine readable instructions being provided on a machine readable medium and when executed to cause position detection circuitry, to:
receive a first sensor signal from the first sensor;
receive a second sensor signal from the second sensor;
determine an error due to any impairment to one or more of the spaced regions of the encoder strip based upon a comparison between samples of the first detection signal and samples of the second detection signal; when the first sensor and second sensor move relative to the encoder strip; and
determine a movement characteristic of the print head carriage from at least one of:
the samples of the first detection signal; and
the samples of the second detection signal.

14. Machine readable instructions of claim 13, comprising instructions to reset a position indicator of the carriage upon detection of an index region of the encoder member by one of the first sensor and the second sensor, the index region to cause a response by the first sensor and the second sensor different from that of a main region of the encoder member.

15. A method of detecting movement of a moveable component having an encoder member with a plurality of spaced regions to cause a response by a first detector and a second detector, the method comprising:
receiving a first detection signal from the first detector;
receiving a second detection signal from the second detector; and
sampling at least one of the first detection signal and the second detection signal when the first detector and second detector move relative to the encoder member;
detecting an error due to any impairment to one the spaced regions of the encoder member based upon a comparison between the samples of the first detection signal and the samples of the second detection signal
determining a movement characteristic of the moveable component from at least one of:
the samples of the first detection signal; and
the samples of the second detection signal.
